(19) United States
(12) Patent Application Publication
(10) Pub. No.: US 2026/0291126 A1
(43) Pub. Date: Sep. 24, 2026

(54) PLUG CONNECTOR, PREFERABLY CHARGING PLUG CONNECTOR, HAVING A LOCKING DEVICE

(71) Applicant: Phoenix Contact E-Mobility GmbH, Schieder-Schwalenberg (DE)

(72) Inventors: Marco SEELIG, Leopoldshöhe (DE); Stephan GIESBRECHT, Detmold (DE)

(21) Appl. No.: 19/570,229

(22) Filed: Mar. 18, 2026

(30) Foreign Application Priority Data
Mar. 21, 2025 (DE) 10 2025 110 950.8

(51) Int. Cl. H01R 13/627; B60L 53/16

(52) U.S. Cl. CPC H01R 13/6275; B60L 53/16; H01R 2201/26

(57) ABSTRACT

A plug connector for forming a plug connection with a mating plug connector in a plug-in direction in order to transmit electrical energy and/or electrical signals in an operating state of the plug connector includes: a housing with a plug portion in which at least one contact element is arranged to form a plug face; a locking device having a latching element for forming a latching connection with the mating plug connector in a plugged-in state; and a holding element for removably assembling the latching element. The latching element includes a predetermined breaking portion so as to prevent the plug connector from being overloaded to a specific degree when separating the plug connector from the mating plug connector.

### CROSS-REFERENCE TO PRIOR APPLICATION

Priority is claimed to German Patent Application No. DE 10 2025 110 950.8, filed on Mar. 21, 2025, the entire disclosure of which is hereby incorporated by reference herein.

### FIELD

The present invention lies in the field of electrical power supply technology, preferably charging technology in the field of electromobility, and relates to a plug connector, preferably a charging plug connector, having a locking device.

### BACKGROUND

Plug connectors have different configurations depending upon their intended use and field of application and must meet a variety of requirements. For example, in the field of electromobility, plug connectors are used as manually operable charging plug connectors. Charging plug connectors at charging stations for providing electromobility are, along with charging cables, usually in use daily. Both charging plug connectors and charging cables are exposed to various environmental loads and influences. For example, mechanical loads on charging plug connectors arise during handling. Mechanical loads can occur, for example, in the form of blows or impacts, such as when the charging plug connector is accidentally dropped along with the charging cable. Furthermore, improper handling of a charging plug connector can lead to damage or destruction, resulting in the failure of the charging plug connector.

Due to the usage situation, the main focus is on requirements for ensuring electrical safety, the quality of the charging cable, and the quality of the connection between the charging plug connector and a mating plug connector in the form of a charging socket.

Even minor damage to a charging cable usually requires the charging cable to be replaced. To prevent damage to charging cables and associated functional impairments, it may be necessary to mechanically lock the charging plug connector with the mating plug connector in addition to forming a plug connection during a charging process.

In known charging systems, for example, a locking element of the charging plug connector can be damaged as a result of being dropped. This can lead to an unsafe operating state or to the complete failure of the charging technology. Due to the design, replacing damaged locking elements is either impossible, difficult, or requires disproportionate effort, often also requiring the charging cable to be replaced. Furthermore, locking elements are subject to a certain amount of wear due to high mating cycle numbers and associated mechanical loads.

Locking mechanisms are known, for example, from published German application DE 10 2011 050 783 A1 or from German patent DE 10 2007 056 458 B4.

### SUMMARY

In an embodiment, the present invention provides a plug connector for forming a plug connection with a mating plug connector in a plug-in direction in order to transmit electrical energy and/or electrical signals in an operating state of the plug connector, the plug connector comprising: a housing with a plug portion in which at least one contact element is arranged to form a plug face; a locking device comprising a latching element configured to form a latching connection with the mating plug connector in a plugged-in state; and a holding element configured for removably assembling the latching element, wherein the latching element comprises a predetermined breaking portion so as to prevent the plug connector from being overloaded to a specific degree when separating the plug connector from the mating plug connector.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 is a perspectival view of a first exemplary embodiment the plug connector according to the present invention;

FIG. 2 is an exploded view of the locking device of the plug connector from FIG. 1, in which the elements of the locking device are shown separately from one another;

FIG. 3 is a frontal view (main view) of the elements of the locking device from FIG. 2, in which the elements of the locking device are shown separately from one another;

FIG. 4 is a frontal view (main view) of the elements of the locking device from FIG. 3, in which the elements of the locking device are shown in an assembled state; and

FIG. 5 is a perspectival view of the latching element and the connecting element of the locking device from FIG. 2.

### DETAILED DESCRIPTION

In an embodiment, the present invention provides a plug connector, preferably a charging plug connector, for transmitting electrical energy and/or electrical signals, having a locking device, wherein the locking device is improved especially with regard to its design, assembly/disassembly, and maintenance.

According to a first general aspect, the present invention relates to a plug connector, preferably a charging plug connector, for forming a plug connection with a mating plug connector substantially in a plug-in direction in order to transmit electrical energy and/or electrical signals in an operating state of the plug connector, wherein the plug connector comprises a housing with a plug portion in which at least one contact element is arranged to form a plug face, wherein the plug connector comprises a locking device for locking with the mating plug connector, which comprises a latching element for forming a latching connection with the mating plug connector in a plugged-in state, and a holding element for removably assembling the latching element, wherein the latching element comprises a predetermined breaking portion in order to preferably prevent the plug connector, preferably the holding element, from being overloaded to a specific degree when separating the plug connector from the mating plug connector.

The present invention may provide a plug connector, preferably a charging plug connector, which is characterized by the predetermined breaking portion of the latching element, thereby providing mechanical overload protection for the plug connector, preferably for the holding element. The predetermined breaking portion may comprise a predetermined breaking point. The predetermined breaking portion can, for example, protect other components of the locking device from irreparable damage. The predetermined breaking portion can be configured to break or at least deform when subjected to a load of defined magnitude during the separation process, preferably substantially in the plug-in direction each time. The load of defined magnitude can be a tensile force and, consequently or as a result, tensile stress. The predetermined breaking portion allows the latching element to be weakened to a specific degree, preferably at a defined point, to ensure controlled breaking or controlled deformation. In other words, in a corresponding load case, the latching element can ensure controlled failure without damaging the rest of the locking device. The latching element can be characterized by a simple and cost-effective construction in terms of its geometric design.

Furthermore, by being able to removably assemble the latching element on the holding element, for example, it is possible to replace the latching element in case of damage, such as deformation or breakage. Other components of the locking device and thus of the plug connector, such as preferably the holding element, do not need to be replaced.

The plug connector can be a plug connector that may be handled and/or carried by hand. The plug connector can be a charging plug connector of an electromobility charging station and can be connected to a charging column via a charging cable. The housing can be a multi-part housing and, if the plug connector is designed as a charging plug connector, may comprise a carrier housing part and a frame housing part. The plug face of the plug connector can be a standardized plug face, e.g., according to the IEC 62196-2 standard or according to the IEC 62196-3 standard.

The specific degree of overload can be a mechanical load of a corresponding magnitude and/or form, which at least impairs and/or can impair the function of the plug connector. The mechanical load can be a tensile load, a bending load, and/or a torsional load. The specific degree of overload can be a mechanical load that leads to deformation and/or breakage of at least one component of the plug connector. The specific degree of overload can include elastic and/or plastic deformation.

According to a further aspect of the present invention, it can be provided that the latching element intended to be removably assembled on the holding element comprise an assembly portion which is configured to form at least one releasable, substantially interlocking connection and/or at least one releasable, substantially non-positive connection with a holding portion of the holding element substantially in the plug-in direction, wherein the at least one releasable, substantially interlocking connection preferably comprises a plug connection substantially in the plug-in direction and/or wherein the at least one releasable, substantially non-positive connection preferably comprises a screw connection substantially in the plug-in direction.

This allows, for example, for relatively simple yet robust releasable fastening of the latching element to the holding element. Furthermore, the latching element can be assembled in a single direction, preferably substantially in the plug-in direction. In other words, assembly and disassembly can be achieved by forming relatively simple connection types, which, among other things, can ensure quick replacement of the latching element if necessary.

The locking device can comprise a single connecting element for removably assembling the latching element on the holding element, which connecting element is configured to form a single releasable, substantially non-positive connection between the latching element and the holding element, wherein the single connecting element is preferably designed as a screw element.

The connecting element can be designed as a round head screw, preferably as a tallow-drop screw or as a cheese-head screw - for example, each with a hexagonal socket profile for engagement with and/or actuation by a tool. The tool can be a manually operable screwdriver of a correspondingly complementary design.

For example, the number of different parts in the locking device can be further reduced by using a single connecting element. Furthermore, this can further simplify and shorten the process of assembling/disassembling the latching element on/from the holding element.

According to a further aspect of the present invention, it can be provided that the latching element comprise a recess for guiding a connecting element, preferably a single connecting element, of the locking device, which is configured to form a releasable, substantially non-positive connection between the latching element and the holding element, wherein the recess in the latching element partially extends substantially in the plug-in direction and/or wherein the recess is arranged and/or formed so as to be offset in the plug-in direction with respect to the predetermined breaking portion.

This ensures, for example, further simplified assembly and disassembly of the latching element. The recess can be partially groove-shaped or channel-shaped. The recess can be designed to be substantially complementary to an actuation portion of the connecting element.

It is possible that the locking device, preferably the holding element, is mounted in a defined location within the housing, preferably pivotally mounted, and at least the latching element passes through an opening in the housing in the plug-in direction, wherein the predetermined breaking portion is arranged at least partially outside the housing and/or at least partially inside the housing in the plug-in direction.

By mounting the locking device, preferably of the holding element, within the housing, the plug connector can be locked to the mating plug connector. It goes without saying that this also ensures that it can be unlocked. The defined location can include a defined position and/or a defined orientation.

According to a further aspect of the present invention, it can be provided that the housing opening be formed in an end wall of the housing to delimit the plug portion in the plug-in direction, and that the housing opening be formed for the insertion and/or passage of a tool, preferably a manually operable screwdriving tool, in order to assemble the latching element on the holding element or to disassemble it from the holding element by means of a connecting element of the locking device.

This allows the latching element to be changed in a relatively simple way, without having to open the plug connector housing. The screwdriving tool can be a screwdriver that is known from the prior art.

It is possible that the latching element comprises a latching portion for forming the latching connection and an assembly portion for assembly on the holding element, wherein the predetermined breaking portion is arranged and/or formed between the latching portion and the assembly portion, wherein, when viewing the latching element, preferably from the front (main view), the predetermined breaking portion is tapered relative to both the latching portion and the assembly portion.

The predetermined breaking portion can, for example, be substantially flat and/or substantially plate-shaped. The predetermined breaking portion can be the smallest portion of the latching element in terms of its geometric dimensions in at least one direction, preferably perpendicularly to the plug-in direction.

According to a further aspect of the present invention, it can be provided that the predetermined breaking portion be formed from a material of lower or substantially identical strength and/or toughness, preferably fracture toughness, than the material of adjacent portions of the latching element.

This allows, for example, the predetermined breaking function to be implemented at a defined point.

It is possible that the latching element comprises a latching portion for forming the latching connection and an assembly portion for assembly on the holding element, wherein the predetermined breaking portion is arranged and/or designed so as to be at least partially offset from each of the latching portion and the assembly portion, wherein the latching element is preferably hook-shaped.

According to a further aspect of the present invention, it can be provided that the latching element and the holding element be integrally formed in one piece and/or each formed as a separate individual part, preferably by at least one of the following processes: injection-molding, casting, sintering, 3-D printing, curing, shrinking, and heat-treatment.

The heat-treatment process can, for example, be configured to form the predetermined breaking portion.

The previously described exemplary embodiments and features of the present invention can be combined with one another as desired or as appropriate. Further or other details and advantageous effects of the present invention are explained in more detail below with reference to accompanying figures.

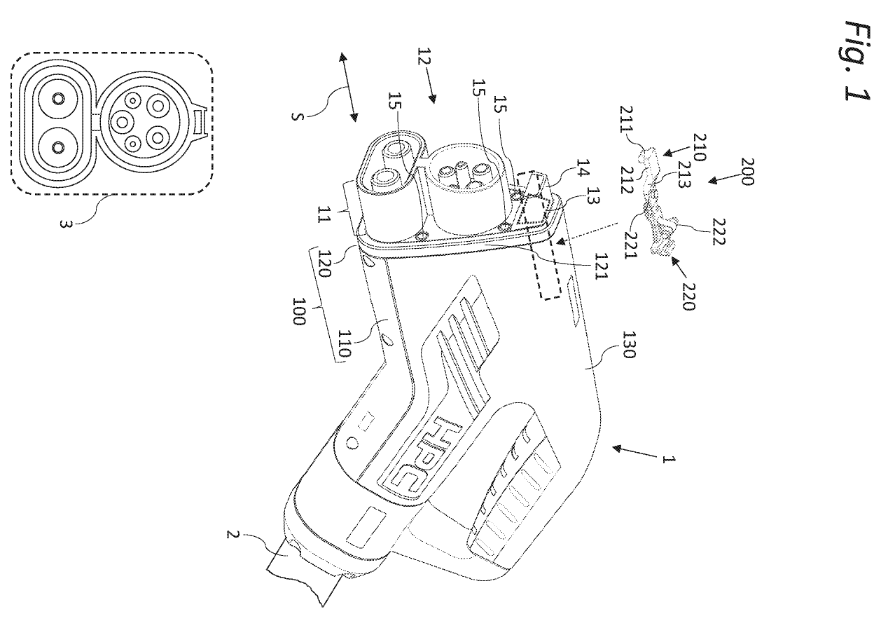

FIG. 1 is a perspectival view of a first exemplary embodiment of a plug connector 1 according to the present invention.

The plug connector 1 is configured and/or designed as a charging plug connector 1. The plug connector 1 is connected to charging cable 2, which in turn can be connected to a charging column of a station or a so-called wallbox (hidden for reasons of clarity).

The charging plug connector 1 is configured to form a plug connection with a mating plug connector 3 substantially in a plug-in direction S in order to transmit electrical energy and/or electrical signals in an operating state of the charging plug connector 1. The mating plug connector 3 is a charging socket of an electrically powered vehicle (electric vehicle) and is shown schematically simplified in FIG. 1 in the form of a mating plug face.

The charging plug connector 1 is a mobile charging plug connector 1 that is or can be held by hand, manually operated, and/or carried by hand. The charging plug connector 1 is usually referred to as a "charging plug" for short.

The charging plug connector 1 is preferably specified according to the IEC 62196-2 standard or according to the IEC 62196-3 standard or is preferably at least partially based upon the requirements of the IEC 62196-2 or IEC 62196-3 standard. In an alternative exemplary embodiment of the charging plug connector 1, it can also be designed as a so-called Combo-1 charging plug connector (“Type 1 connector”) according to US standards and/or specifications. Alternatively, it is possible for the charging plug connector 1 to be designed and/or specified according to another standard or another specification - for example, according to the so-called "CHAdeMO standard" or according to the so-called "ChaoJi stacked specification."

The charging plug connector 1 is configured for charging accumulators of electrically powered vehicles (electric vehicles) and, when assembled, is connected via the charging cable 2 to a charging station, preferably a charging management unit of the charging station, among other things, for this purpose. The charging management unit serves, among other things, to adjust, preferably control using open-loop and/or closed-loop control, electrical energy to be transmitted via the charging cable 2 to the charging plug connector 1 and also to the mating plug connector 3 of the electrically powered vehicle.

The charging plug connector 1 comprises a housing 100 having a plug portion 11 in which contact elements are arranged to form a plug face 12.

The charging plug connector 1 is preferably used for charging via direct current and comprises load contact elements for this purpose. An electrical voltage in the form of a DC voltage applied to the load contact elements during a charging process can, for example, range from 400 volts to 1,000 volts. The charging plug connector 1 is preferably configured for high power charging (HPC). During a charging process, the electrical energy in the form of a charging voltage and/or a charging current is transmitted from the charging station via each of the electrical conductors of the charging cable 2, which are electrically connected to the load contact elements.

The charging plug connector 1 comprises further contact elements for transmitting electrical signals, preferably communication signals, between the charging station, the charging plug connector 1, and the electrically powered vehicle during a charging process.

The housing 100 is preferably made up of several parts and comprises, among other things, separately designed and/or manufactured carrier housing parts 110 and 130. The frame part 120 is also an individual component that is separately designed and/or manufactured from the carrier housing parts 110 and 130 and is partially plugged into the carrier housing parts 110 and 130. Through openings 15 are provided for fastening the plug portion 11, by means of which releasable screw connections can be formed in conjunction with screw elements. It is possible that the frame part 120 is made up of multiple parts. The carrier housing part 130 serves, among other things, for handling the charging plug connector 1 and comprises, for example, a handle for this purpose.

The carrier housing parts 110, 130 and the frame part 120 are each made of an insulating material and thus of an insulating material with inherent electrical insulating properties and resulting insulating capabilities. The insulating material can preferably be based upon a plastic in order to provide protection against contact with electrically conductive elements. The carrier housing parts 110, 130 and the frame part 120 are each made from an insulating material - for example, by at least one casting process and/or by at least one injection-molding process.

For locking with the mating plug connector 3, the charging plug connector 1 comprises a locking device 200. The locking device 200 comprises a latching element 210 and a holding element 220. The latching element 210 is configured to form a latching connection with the mating plug connector 3 in a plugged-in state and/or during a plugging-in process. The holding element 220 is configured for assembling, preferably in a removable or replaceable manner, the latching element 210. For assembling the latching element 210 on the holding element 220, the holding element 220 comprises the holding portion 221. A bearing portion 222 of the holding element 220 serves to pivotally mount the holding element 220 within the carrier housing part 130 in order to ensure actuation of the latching element 210 during handling of the charging plug connector 1.

The latching element 210 comprises a predetermined breaking portion 212 to prevent the plug connector 1, preferably the holding element 220, from being overloaded to a specific degree when separating the charging plug connector 1 - for example, as a result of faulty, improper, and/or incorrect handling of the charging plug connector 1.

In other words, the latching element 210 is characterized by a predetermined breaking function which prevents the introduction of mechanical loads into the housing 100 of the charging plug connector 1 (preferably in the form of tensile loads, bending loads, and/or torsional loads) which reach and/or exceed a specified limit value. The functionality of the latching element 210, for example, prevents damage to or destruction of the charging plug connector 1, preferably of the holding element 220.

The locking device 200, i.e., the holding element 220, is mounted in a defined location within the carrier housing part 130 so that the latching element 210 passes through the housing opening 13 in the plug-in direction S (see the closed dashed line in FIG. 1 for further illustration). The housing opening 13 is formed in an end wall 121 of the frame part 120. The end wall 121 serves on the one hand to delimit the plug portion 11 in the plug-in direction S, and, on the other, to cover the inner region of the carrier housing parts 110, 130.

A shielding wall 14 serves to protect the latching element 210 in at least one direction. The shielding wall 14 is arranged and/or formed on the end wall 121 and partially extends in the plug-in direction S away from the end wall 121.

The geometric dimensions of the housing opening 13 allow a manually operable tool to be passed through the housing opening 13 for the assembly and disassembly of the latching element 210. The housing opening 13 forms, among other things, a component of the plug face 12 and, as a result of mounting the locking device 200 in the defined location, is preferably arranged in an edge region of the plug portion 11.

The locking device 200 is preferably mounted in a defined location such that the predetermined breaking portion 212 is arranged at least partially outside the housing 100 in the plug-in direction S and thus projects into the plug portion 11.

The functionality and configuration of the locking device 200 will be described with reference to the other figures. For the sake of clarity, only particular components of the locking device 200 are shown in the following figures.

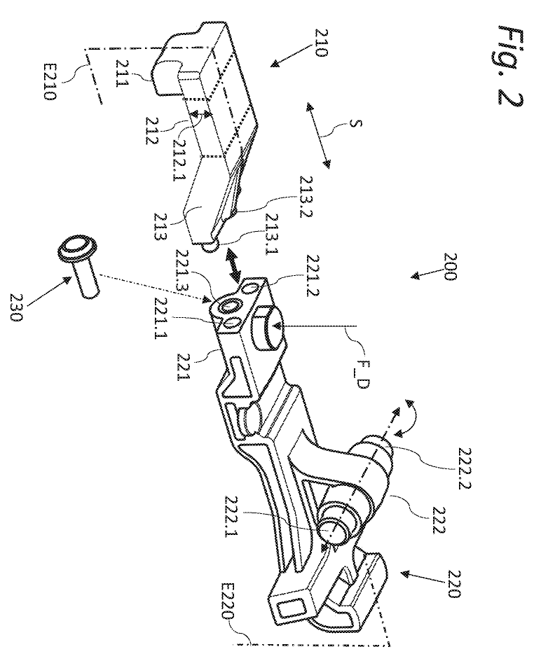

FIG. 2 is an exploded view of the locking device 200 of the charging plug connector 1 from FIG. 1, in which the elements 210, 220, 230 of the locking device 200 are shown separately from one another.

The locking device 200 is formed of multiple parts and preferably comprises only three elements. In addition to the latching element 210 and the holding element 220, the locking device 200 comprises the connecting element 230 for removably and thus detachably assembling the latching element 210 on the holding element 220.

The latching element 210 is substantially hook-shaped. The latching element 210 is substantially mirror-symmetrical with respect to an element plane E210 as a median plane in the plug-in direction S. The latching element 210 comprises the latching portion 211, the predetermined breaking portion 212, and the assembly portion 213. The predetermined breaking portion 212 is arranged and/or formed between the latching portion 211 and the assembly portion 213. The portions 211, 212, 213 are adjacent to one another and/or merge directly into one another.

The predetermined breaking portion 212 is designed in a comparatively simple manner compared to the latching portion 211 and the assembly portion 213. The predetermined breaking portion 212 is substantially plate-shaped and substantially flat. The predetermined breaking portion 212 is substantially characterized by the thickness 212.1. To realize the predetermined breaking function as disclosed herein, the predetermined breaking portion 212 can be made of a material of lower strength and/or toughness than a material of the adjacent portions 211, 213 of the latching element 210. The predetermined breaking portion 212 is tapered in relation to the latching portion 211 and the assembly portion 213. In other words, the predetermined breaking portion 212 represents a portion which in terms of geometric dimensions and/or material properties is accordingly designed, preferably weakened, in order to avoid a specific degree of overload, as disclosed herein, especially when the charging plug connector 1 is separated from the mating plug connector 3.

The latching portion 211 extends substantially perpendicularly to the predetermined breaking portion 212. The latching portion 211 is designed as a latching cam, which transitions directly into the predetermined breaking portion 212 or connects to the predetermined breaking portion 212.

The assembly portion 213 is substantially plate-shaped and is arranged, aligned, and/or formed at an angle to the predetermined breaking portion 212.

As already described, the predetermined breaking portion 212 serves to implement the predetermined breaking function in order to prevent the structure of the charging plug connector 1 and thus of the housing 100, preferably of the holding element 220, as well as other units and elements of the charging plug connector 1 from being overloaded to a specific degree.

For example, the predetermined breaking portion 212 is designed and/or configured in such a way that mechanical loads in the form of tensile loads (and associated tensile loads in the plug-in direction S), which are generated, for example, by improper handling of the charging plug connector 1 and introduced into the predetermined breaking portion 212 via the latching portion 211, lead to breakage above a certain magnitude. The predetermined breaking portion 212 is designed to be sufficiently stable so that the latching element 210 can perform its intended latching function, while the predetermined breaking portion 212 is designed in such a way that, for example, overload fracture occurs when or after the material of the predetermined breaking portion 212 has reached a defined yield point.

By means of the predetermined breaking portion 212, defined, preferably controlled, failure of the latching element 210 can be achieved. The predetermined breaking portion 212 can be designed and/or configured such that a break occurs at the transition between the predetermined breaking portion 212 and the assembly portion 213 and/or the latching portion 211, thereby creating a defined, predetermined breaking point which is characterized by a defined location.

The predetermined breaking portion 212 can be made of a plastic-based material which breaks in a controlled manner under a defined load in order to realize the predetermined breaking function. As already described, the material can be characterized by a defined yield point, above which plastic deformation occurs. Furthermore, the material of the predetermined breaking portion 212 can be characterized by a defined breaking strength, which represents the maximum stress at which the predetermined breaking portion 212 fails.

The holding element 220 is substantially mirror-symmetrical to an element plane E220. For pivotally mounting the holding element 220 in the defined location and thus at a defined position and/or in a defined orientation within the carrier housing part 130, the holding element 220 comprises the bearing portion 222 having the bearing bolts 222.1 and 222.2, which are arranged and/or formed opposite one another. The holding element 220 is configured to be subjected to a pressure force F_D, which acts substantially perpendicularly to the plug-in direction S. The pressure force F_D can be generated by a spring element. The pressure force F_D presses the holding element 220 into a defined location to maintain a latching connection that has been formed and thus to ensure locking with the mating plug connector 3.

The latching element 210 is configured to be removably (replaceably) assembled on the holding element 220 and comprises the assembly portion 213 for this purpose. In order to removably assemble the latching element 210 on the holding element 220, the holding element 220 comprises the holding portion 221.

The assembly portion 213 is configured to form two plug connections with the holding portion 221 substantially in the plug-in direction S and comprises two plug pins 213.1 and 213.2 for this purpose. The plug pins 213.1, 213.2 are arranged and/or formed on an end face of the assembly portion 213 and, in an assembled state of the locking device 200, engage in associated plug holes 221.1 and 221.2 of the holding portion 221. This results, for example, in the latching element 210 being arranged on the holding element 220, which is characterized by a defined position and orientation.

A connecting element 230 in the form of a screw, which can be designed, for example, as a tallow-drop screw or as a cheese-head screw with a hexagonal socket profile, serves to detachably fasten the latching element 210 to the holding element 220. The connecting element 230 in the form of a screw can also have a different design and comprise a particular actuation profile. To form a screw connection with the connecting element 230, the threaded hole 221.3 is provided on the holding portion 221.

Preferably, the locking device 200 is characterized only by the three elements: the latching element 210, the holding element 220, and the connecting element 230.

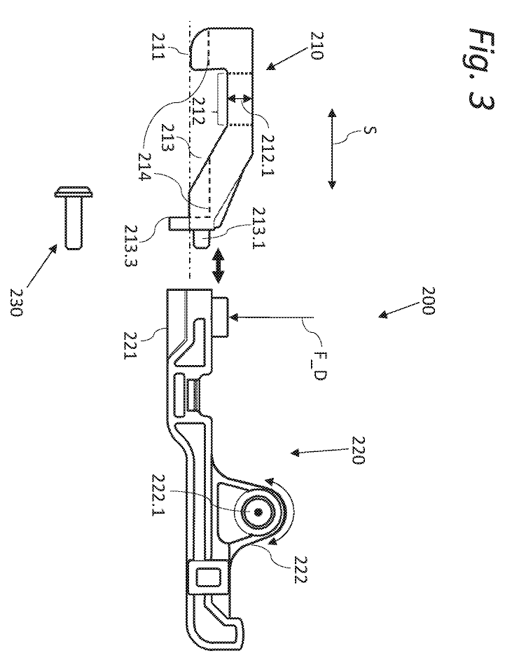

FIG. 3 shows a frontal view (main view) of the elements 210, 220, 230 of the locking device 200 from FIG. 2, in which the elements 210, 220, 230 of the locking device 200 are shown separately from one another.

As can be seen from the illustration in FIG. 3, the latching element 210 comprises a recess 214, the location of which is indicated by a dashed line. The recess 214 serves to guide both the connecting element 230 and a tool for actuating the connecting element 230 in the plug-in direction S during the assembly/disassembly of the latching element 210 on/from the holding element 220. The recess 214 is formed in the latching element 210 and, partially, substantially extends in the plug-in direction S and transitions into a stop 213.3 on the assembly portion 213.

The stop 213.3 serves to support the connecting element 230 when the latching element 210 is assembled. The recess 214 is arranged and/or formed so as to be offset in the plug-in direction S with respect to the predetermined breaking portion 212. Furthermore, the illustration in FIG. 3 shows that the predetermined breaking portion 212 is at least partially offset from the latching portion 211, i.e., from the latching cam, and from the assembly portion 213, which results in the corresponding transmission of mechanical loads such that stress is initially concentrated in the region of the predetermined breaking portion 212.

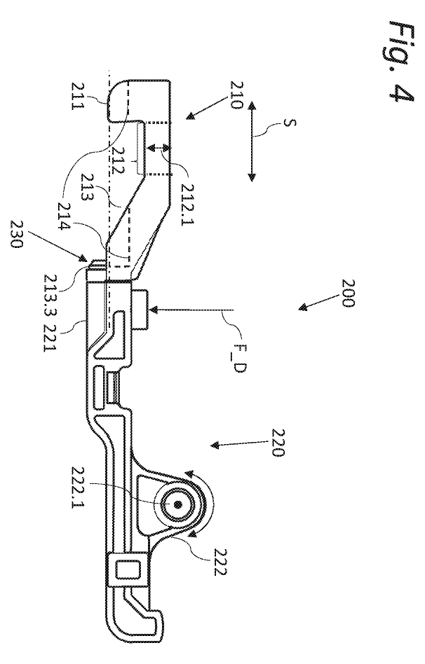

FIG. 4 is a frontal view (main view) of the elements 210, 220, 230 of the locking device 200 from FIG. 3, in which the elements 210, 220, 230 of the locking device 200 are shown in an assembled state.

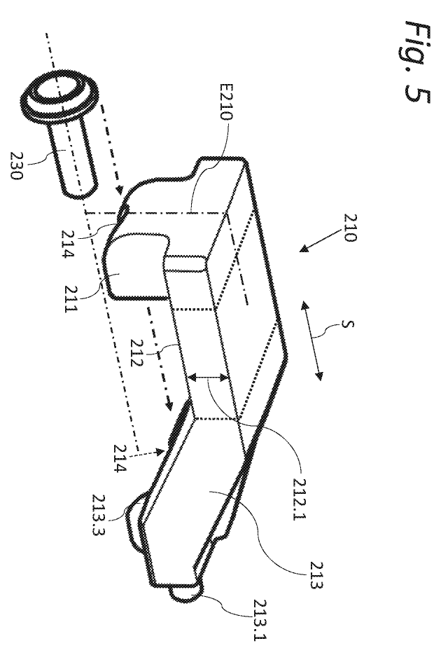

FIG. 5 shows, for further illustration, the latching element 210 and the connecting element 230 of the locking device 200 from FIG. 2 in a perspectival enlarged view in which the formation of the recess 214 in the latching portion 211 can be seen.

The charging plug connector 1 comprises a locking device 200, which, on the one hand, provides effective protection against the other units and elements 220 of the charging plug connector 1 by means of the latching element 210 having the predetermined breaking portion 212. On the other hand, the locking device 200 is characterized by a simple design, simple manufacturing, and easy repairability.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF REFERENCE SIGNS

1 Plug-in connector
2 Charging cable
3 Mating plug connector
11 Plug portion
12 Plug face
13 Housing opening
14 Shielding wall
100 Housing
110 Carrier housing part
130 Carrier housing part
120 Frame part
121 End wall
200 Locking device
210 Latching element
211 Latching portion
212 Predetermined breaking portion
212.1 Thickness
213 Assembly portion
213.1 Plug pin
213.2 Plug pin
213.3 Stop
214 Recess
220 Holding element
221 Holding portion
221.1 Plug hole
221.2 Plug hole
221.3 Threaded hole
222 Bearing portion
222.1 Bearing pin
222.2 Bearing pin
230 Connecting element
E210 Element level
E220 Element level
F_D Pressure force
S Plug-in direction

1. A plug connector for forming a plug connection with a mating plug connector in a plug-in direction in order to transmit electrical energy and/or electrical signals in an operating state of the plug connector, the plug connector comprising:
a housing with a plug portion in which at least one contact element is arranged to form a plug face;
a locking device comprising a latching element configured to form a latching connection with the mating plug connector in a plugged-in state; and
a holding element configured for removably assembling the latching element,
wherein the latching element comprises a predetermined breaking portion so as to prevent the plug connector from being overloaded to a specific degree when separating the plug connector from the mating plug connector.

2. The plug-in connector of claim 1, wherein the latching element configured to be removably assembled on the holding element comprises an assembly portion configured to form at least one releasable interlocking connection and/or at least one releasable, non-positive connection with a holding portion of the holding element in the plug-in direction.

3. The plug-in connector of claim 1, wherein the locking device comprises a single connecting element configured to form a single, releasable, non-positive connection between the latching element and the holding element.

4. The plug-in connector of claim 1, wherein the latching element comprises a recess for guiding a connecting element of the locking device, which is configured to form a releasable, non-positive connection between the latching element and the holding element,
wherein the recess in the latching element partially extends in the plug-in direction, and/or
wherein the recess is offset from the predetermined breaking portion in the plug-in direction.

5. The plug-in connector of claim 1, wherein the locking device is mounted in a defined location inside the housing and at least the latching element passes through a housing opening of the housing in the plug-in direction, and
wherein the predetermined breaking portion is arranged at least partially outside the housing and/or at least partially inside the housing in the plug-in direction.

6. The plug connector of claim 5, wherein the housing opening is formed in an end wall of the housing to delimit the plug portion in the plug-in direction, and
wherein the housing opening is configured for introduction and/or passage of a tool so as to assemble the latching element on the holding element or to remove the latching element from the retaining element by a connecting element of the locking device.

7. The plug-in connector of claim 1, wherein the latching element comprises a latching portion configured to form the latching connection, and an assembly portion configured to assemble the latching connection on the holding element,
wherein the predetermined breaking portion is arranged between the latching portion and the assembly portion, and
wherein, when viewing the latching element, the predetermined breaking portion is tapered relative to each of the latching portion and the assembly portion.

8. The plug-in connector of claim 1, wherein the predetermined breaking portion comprises a material of lower or identical strength and/or toughness than a material of adjacent portions of the latching element.

9. The plug-in connector of claim 1, wherein the latching element comprises a latching portion configured to form the latching connection, and a mounting portion configured to mount the latching element to the retaining element, and
wherein the predetermined breaking portion is at least partially offset from each of the latching portion and the assembly portion.

10. The plug-in connector of claim 1, wherein the latching element and the holding element are integrally formed in one piece and/or each formed as a separate individual part.

11. The plug-in connector of claim 1, wherein the plug connector comprises a charging plug connector.

12. The plug-in connector of claim 1, wherein the latching element comprises the predetermined breaking portion so as to prevent the holding element from being overloaded to a specific degree when separating the plug connector from the mating plug connector.

13. The plug-in connector of claim 2, wherein the at least one releasable interlocking connection comprises a plug connection in the plug-in direction, and/or
wherein the at least one releasable, non-positive connection comprises a screw connection in the plug-in direction.

14. The plug-in connector of claim 3, wherein the single connecting element comprises a screw element.

15. The plug-in connector of claim 5, wherein the holding element is mounted in the defined location inside the housing and at least the latching element passes through the housing opening of the housing in the plug-in direction.

16. The plug-in connector of claim 6, wherein the tool comprises a manually operable screwdriving tool.

17. The plug-in connector of claim 7, wherein, when viewing the latching element from a front of the latching element, the predetermined breaking portion is tapered relative to each of the latching portion and the assembly portion.

18. The plug-in connector of claim 9, wherein the latching element is hook-shaped.

19. The plug-in connector of claim 10, wherein the latching element and the holding element are integrally formed in one piece and/or each formed as the separate individual part by at least one of: injection-molding, casting, sintering, 3-D printing, curing, shrinking, and heat-treatment.
